(19) United States
(12) Patent Application Publication
(10) Pub. No.: US 2003/0196526 A1
(43) Pub. Date: Oct. 23, 2003

(54) Pliers

(76) Inventor: Pang-Chung Wang, Taichung (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/126,136

(22) Filed: Apr. 19, 2002

(51) Int. Cl. B25B 7/12

(52) U.S. Cl. 81/367

(57) ABSTRACT

A pair of pliers including a first handle, a bolt movably mounted on the first handle, a first jaw secured to the first handle, a second jaw linked to the first handle, a spring connected between the first handle and the second jaw, a second handle linked to the second jaw, a strut linked to the second handle at an end and abutting the bolt at another end, and a lever linked to the second handle for control over the strut. The first jaw includes a tooth formed thereon and a flat edge formed next to the tooth. The second jaw includes a tooth and a concave edge formed next to the tooth thereof.

### BACKGROUND OF INVENTION

1. Field of Invention

The present invention is related to a pair of pliers and more particularly to a pair of pliers that can retain a jaw thereof in position relative to another jaw thereof.

2. Related Prior Art

FIG. 9 shows a conventional pair of pliers that includes a body 10 with a first jaw 11 and a first handle (not numbered) extending from the jaw 11. A second jaw 12 is I 11 linked to the body 10 by means of a pin 13. A spring 17 includes an end secured to the second jaw 12 and an opposite end secured to the first handle. A second handle 14 is linked to the second jaw 12. A strut 15 is linked to the second handle 14. A bolt 16 is engaged with the first handle. A tip 151 of the strut 15 abuts a tip 161 of the bolt 16. A lever 18 is linked to the second handle 14. The lever 18 includes a first section 181 and a second section 182. The strut 15 includes an elbow 152 in contact with the second section 182 of the lever 18.

This conventional pair of pliers can be used to drive a pipe with a smooth periphery or a bolt with a hexangular head. In use, the pipe or hexangular head is put between the jaws 11 and 12. The bolt 16 is rotated in order to adjust the position of the second jaw 12 relative to the first jaw 11 based on the size of the pipe or hexangular head. The second handle 14 is pressed toward the first handle so that the jaws 11 and 12 close in and bites the pipe or hexangular head. The elbow 152 moves the second section 182 of the lever 18 toward the second handle 14, thus moving the first section 181 of the lever 18 away from the second handle 14. The pair of pliers is retained in this position by means of the spring 17. Thus, a user does not have to grip the handles hard while rotating the pipe or bolt.

When using the pair of pliers in a limited space, the user has to release the jaws from the pipe or hexangular head by moving the first section 181 of the lever 18 toward the second handle 14 after rotating the pipe or bolt by an angle. The afore-mentioned process has to be repeated in order to rotate the pipe or bolt by another angle. This is inconvenient.

The present invention is therefore intended to obviate or at least alleviate the problems encountered in prior art.

### SUMMARY OF INVENTION

It is an objective of the present invention to provide a pair of pliers that can retain a jaw thereof in position relative to another jaw thereof and is particularly convenient in driving a hexangular head of a bolt.

According to the present invention, a pair of pliers including a first handle, a bolt movably mounted on the first handle, a first jaw secured to the first handle, a second jaw linked to the first handle, a spring connected between the first handle and the second jaw, a second handle linked to the second jaw, a strut linked to the second handle at an end and abutting the bolt at another end, and a lever linked to the second handle for control over the strut. The first jaw includes a tooth formed thereon and a flat edge formed next to the tooth. The second jaw includes a tooth and a concave edge formed next to the tooth thereof.

The first handle includes a first section to which the first jaw is secured and a second section on which the bolt is movably mounted.

The second section of the first handle defines a window through which a tip of the bolt can be seen. Two scales are marked on the second section of the first handle beside the window. The scales are calibrated so that a reading of the tip of the bolt in the scales indicates a distance between the tips of the jaws and or the size of an article to be driven by means of the pair of pliers.

The first handle includes a hook projecting from the second section thereof for hooking an end of the spring.

The first jaw may be secured to the first section of the handle by means of pin or soldering. Alternatively, the first handle and the first jaw may be made two portions of a single element.

The pair of pliers includes a pin for linking the second jaw to the first handle.

The pair of pliers includes a pin for linking the second handle to the second jaw.

The pair of pliers includes a pin for linking the strut to the second handle.

The strut includes an elbow formed thereon for contact with the lever.

The pair of pliers includes a pin for linking the lever to the second handle, thus dividing the lever into a first section to be pressed and a second section for contact with the elbow of the strut.

The first jaw may include a series of miniature teeth formed next to the flat edge, and the second jaw may include a series of miniature teeth formed next to the tooth.

Other objects, advantages, and novel features of the invention will become more apparent from the following detailed description when taken in conjunction with the attached drawings.

### BRIEF DESCRIPTION OF DRAWINGS

The present invention is described through detailed illustration of embodiments referring to the attached drawings wherein:

FIG. 1 is a perspective view of a pair of pliers in accordance with an embodiment of the present invention;

FIG. 2 is a cross-sectional view of the pair of pliers shown in FIG. 1

FIG. 3 is similar to FIG. 2 except for showing the pair of pliers engaged with a head of a bolt;

FIG. 4 is similar to FIG. 3 except for showing the head rotated clockwise by 90 degrees from the position shown in FIG. 3 by means of the pair of pliers;

FIG. 5 is similar to FIG. 4 except for showing counterclockwise rotation of the pair of pliers by an angle from the position shown in FIG. 4 without rotation of the head;

FIG. 6 is a side view of a pair of pliers according to another embodiment of the preferred embodiment of the present invention;

FIG. 7 is a side view of a pair of pliers according to a third embodiment of the present invention engaged with a head of a bolt;

FIG. 8 is similar to FIG. 7 except for showing the pair of pliers engaged with a pipe; and

FIG. 9 is a side view of a conventional pair of pliers.

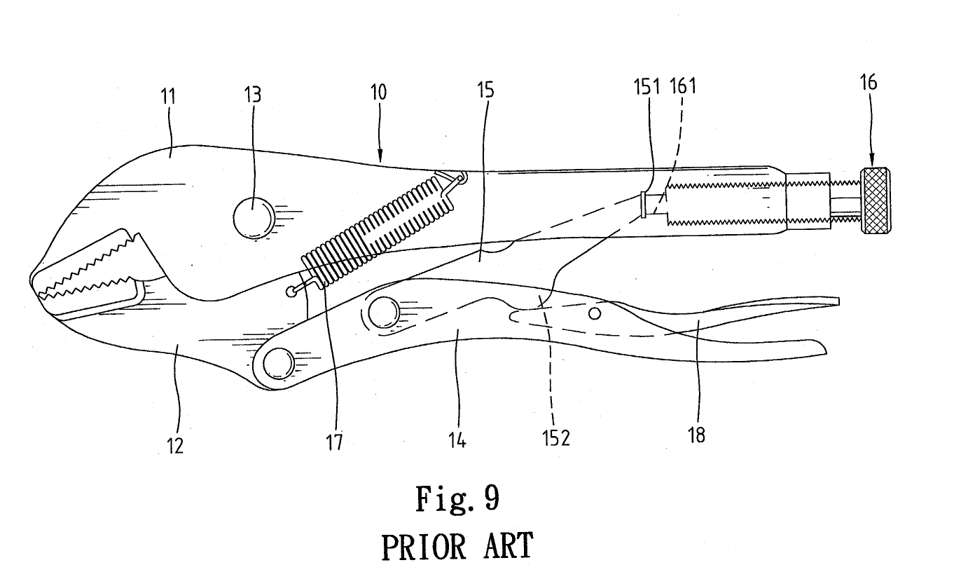

### DETAILED DESCRIPTION OF EMBODIMENTS

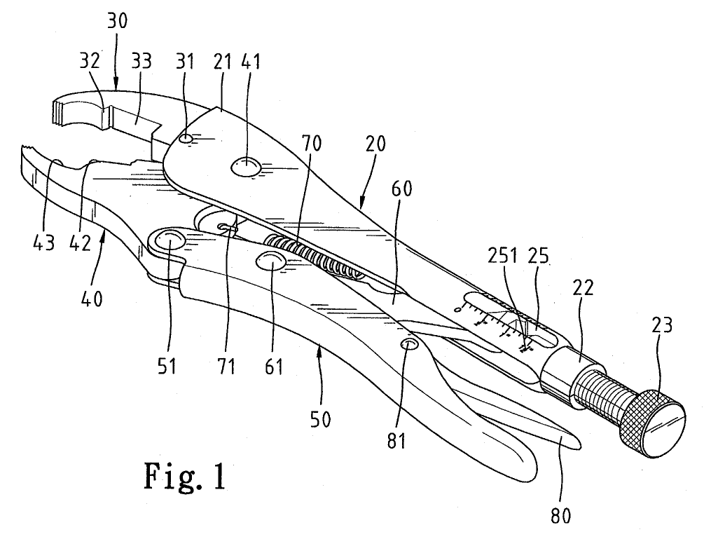

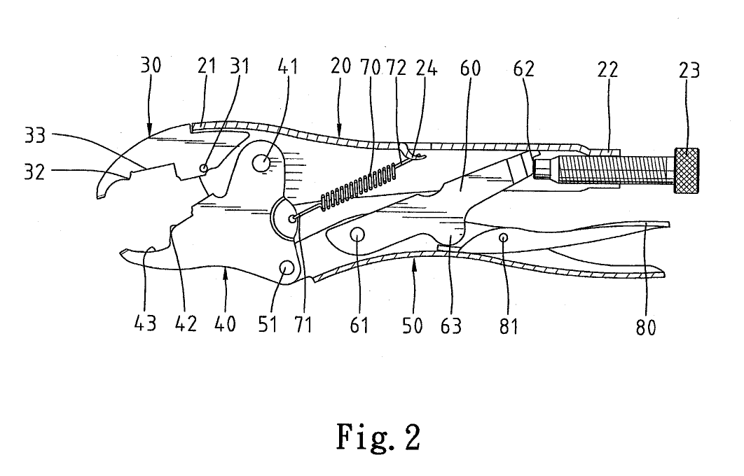

Referring to FIGS. 1 and 2, a pair of pliers according to an embodiment of the present invention includes a first handle 20, a first jaw 30, a second jaw 40, a second handle 50, a strut 60, a spring 70 and a lever 80.

The first handle 20 includes a first section 21 and a second section 22. The second section 22 of the first handle 20 is engaged with a bolt 23. A hook 24 projects from the second section 22. The second section 22 of the first handle 20 defines a window through which a tip of the bolt 23 can be seen. Two scales 251 are marked on the second section 22 of the first handle 20 beside the window 25. The scales 251 are calibrated so that a reading of the tip of the bolt 23 in the scales 251 indicates a distance between the tips of the jaws 30 and 40 or the size of an article to be driven by means of the pair of pliers.

The first jaw 30 is connected with the first section 21 of the handle 20 by means of a pin 31. The connection of the first handle 20 with the first jaw 30 may be enhanced by means of soldering. Thus, the first handle 20 and the first jaw 30 are integrated with each other. The first jaw 30 includes a tooth 32 projecting from a flat edge 33. In this embodiment, the first handle 20 and the first jaw 30 are made two elements so that the first jaw 30 can be fabricated positively and, more particularly, the tooth 32 and the flat edge 33 can be shaped positively. However, the first handle 20 and the first jaw 30 can be made two portions of a single element.

The second jaw 40 is linked to the first handle 20 by means of a pin 41. The second jaw 40 can be pivoted relative to the first handle 20. The spring 70 includes an end secured to the second jaw 40 and another end 72 secured to the first handle 30. The first end 71 of the spring 70 is inserted through a hole defined in the second jaw 12, and the second end 72 of the spring 70 is hooked to the hook 24 projecting from the first handle 20. The second jaw 40 includes a tooth 42 and a concave edge 43 formed next to the tooth 42.

The second handle 50 is linked to the second jaw 40 by means of a pin 51. The second handle 50 can be pivoted relative to the second jaw 40.

The strut 60 includes a first end, a second end 62 and an elbow 63 formed between the first and second ends thereof. The first end of the strut 60 is linked to the second handle 50 by means of a pin 61. Thus, the strut 60 can be pivoted relative to the second handle 50. The second end 62 of the strut 60 abuts a tip of the bolt 23.

The lever 80 is linked to the second handle 50 by means of a pin 81, thus dividing the lever 80 into a first section and a second section. The elbow 63 of the strut 60 can be in contact with the second section of the lever 80.

The pair of pliers according to the present invention is very similar to the conventional pair of pliers described in the Related Prior Art except for including the novel jaws 30 and 40. Therefore, the following description of the pair of pliers according to the present invention will be focused on the jaws 30 and 40.

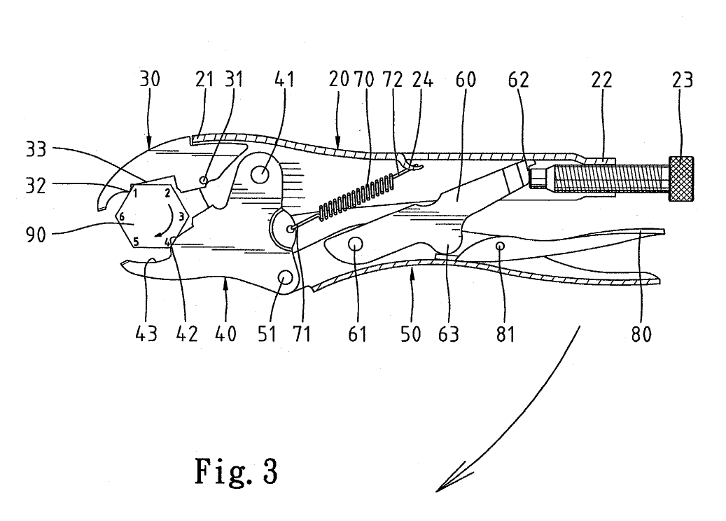

FIG. 3 shows a hexangular head 90 of a bolt (not shown) engaged with the pair of pliers. The hexangular head 90 includes corners 1˜6. To rotate the bolt clockwise, the hexangular head 90 is located between the jaws 30 and 40. The bolt 23 is rotated in order to properly position the second jaw 40 relative to the first jaw 30 based on the size of the hexangular head 90. The second handle 50 is pressed toward the first handle 20 so that the jaws 30 and 40 close in until the tooth 32 abuts the corner 1 from the left and the tooth 42 abuts the corner 4 from the right. The elbow 63 pushes the second section of the lever 80 toward the second handle 50, thus moving the first section of the lever 80 away from the second handle 50. The pair of pliers is retained in this position by means of the spring 70 so that a user does not have to grip the handles 20 and 50 hard while rotating the bolt. For the tooth 32 abuts the corner from the left and the tooth 42 abuts the corner 4 from the right, clockwise pivot of the pair of pliers results in clockwise pivot of the bolt.

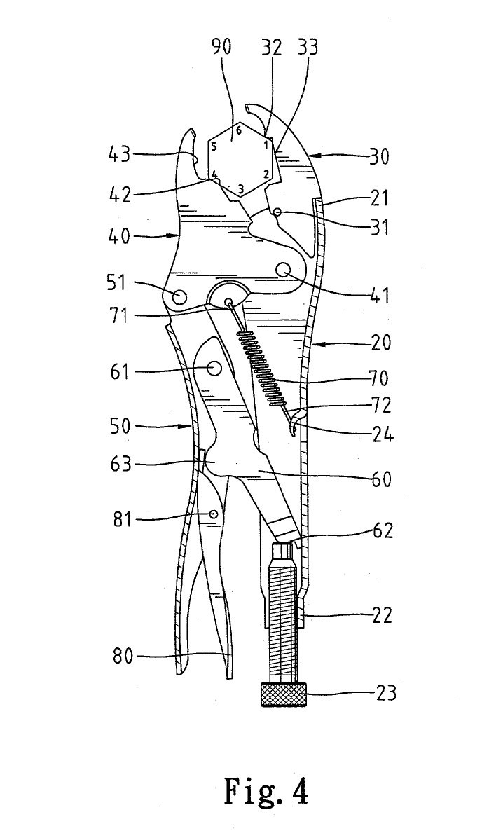

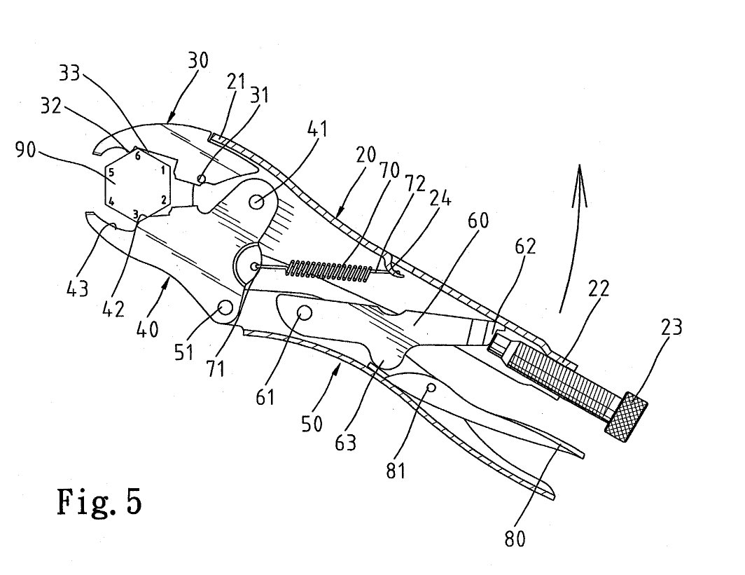

When using the pair of pliers in a limited space, the user may only be allowed to pivot it from the position shown in FIG. 3 to the position shown in FIG. 4 before he or she has to pivot it counterclockwise as shown in FIG. 5. The concave edge 43 of the second jaw 40 allows the jaws 30 and 40 to rotate counterclockwise relative to the hexangular head 90. Thus, the user can pivot the pair of pliers counterclockwise by an angle. When appropriate, the user can pivot the pair of pliers clockwise without rotating the bolt until the tooth 32 abuts a corner of the hexangular head 90 such as the corner 6 from the left and the tooth 42 abuts another corner of the hexangular head 90 such as the corner 4 from the right. Further clockwise pivot of the pair of pliers results in clockwise pivot of the bolt.

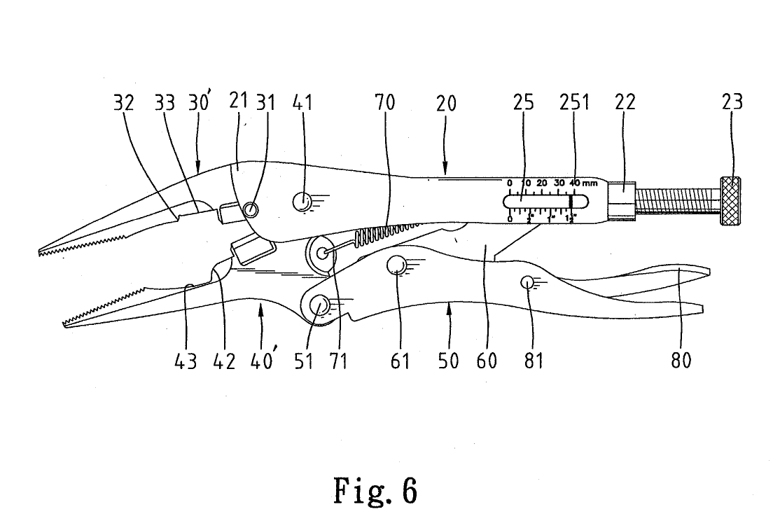

FIG. 6 shows a pair of pliers in accordance with a second embodiment of the present invention. The pair of pliers shown in FIG. 6 is identical to the pair of pliers shown in FIGS. 1˜5 except for including jaws 30′ and 40′ that are longer and sharper than the jaws 30 and 40.

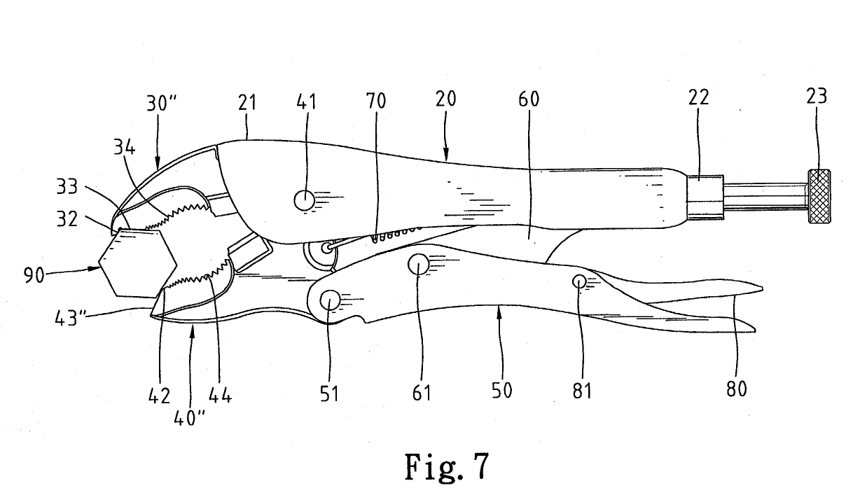

FIG. 7 shows a pair of pliers according to a third embodiment of the present invention. The pair of pliers shown in FIG. 7 is identical to that shown in FIGS. 1˜5 except for including jaws 30″ and 40″ instead of the jaws 30 and 40. The first jaw 30″ is identical to the first jaw 30 except for including a series of the teeth 34 formed to the right of the flat edge 33. The second jaw 40″ is identical to the second jaw 40 except for two features. Firstly, instead of the concave edge 43, an inclined edge 43″ is formed on the second jaw 40″. The inclined edge 43″ extends from the tooth 42 to the tip of the second jaw 40″. Finally, the second jaw 40″ includes a series of the teeth 44 formed to the right of the tooth 42.

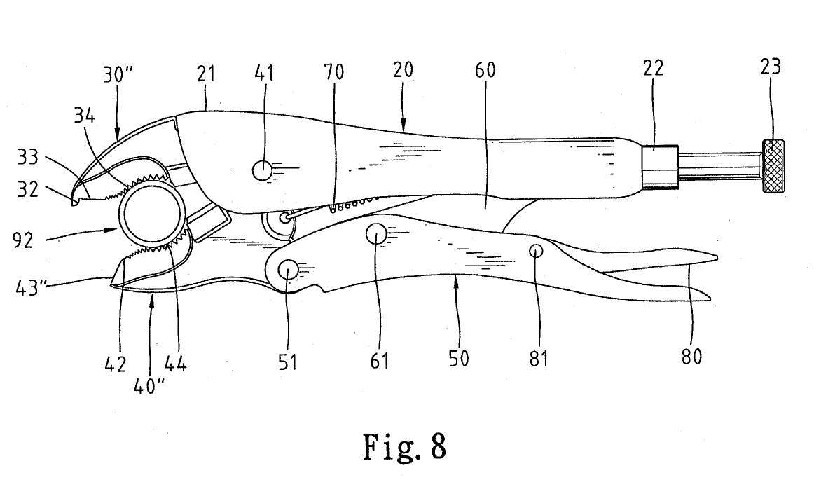

As shown in FIG. 7, the tooth 32 of the first jaw 30″ and the tooth 42 of the second jaw 40″ can be engaged with the hexangular head 90. As shown in FIG. 8, the series of teeth 34 of the first jaw 30″ and the series of teeth 44 of the second jaw 40″ can be engaged with a pipe 92.

The present invention has been described through detailed illustration of the preferred embodiment thereof. Those skilled in the art can derive many variations from the preferred embodiment without departing from the scope of the present invention. Therefore, the preferred embodiment shall not limit the scope of the present invention. The scope of the present invention can only be defined in the attached claims.

1. A pair of pliers including a first handle (20), a bolt (23) movably mounted on the first handle, a first jaw (30; 30′; 30″) secured to the first handle, a second jaw (40; 40′; 40″) linked to the first handle, a spring (70) connected between the first handle and the second jaw, a second handle (50) linked to the second jaw, a strut (60) linked to the second handle at an end and abutting the bolt at another end, and a lever (80) linked to the second handle for driving the strut, wherein the first jaw includes a tooth (32) formed thereon and a flat edge (33) formed next to the tooth, where the second jaw includes a tooth (42) formed thereon and a concave edge (43) formed next to the tooth (42) of the second jaw.

2. The pair of pliers according to claim 1 wherein the first handle includes a first section (21) to which the first jaw is secured and a second section (22) on which the bolt is movably mounted.

3. The pair of pliers according to claim 2 wherein the second section of the first handle defines a window (25) through which a tip of the bolt can be seen and includes at least one scale (251) marked on the second section of the first handle beside the window for providing a reading of the tip of the bolt.

4. The pair of pliers according to claim 3 wherein the reading indicates a distance between the tips of the first and second jaws.

5. The pair of pliers according to claim 3 wherein the reading indicates a size of an article to be driven by means of the pair of pliers.

6. The pair of pliers according to claim 1 wherein the first handle includes a hook (24) projecting from the second section thereof for hooking an end of the spring.

7. The pair of pliers according to claim 1 including a pin (31) for securing the first jaw to the first section of the handle.

8. The pair of pliers according to claim 1 wherein the securing of the first jaw to the first handle is performed by means of soldering.

9. The pair of pliers according to claim 1 wherein the first handle is an extension from the first jaw.

10. The pair of pliers according to claim 1 including a pin (41) for linking the second jaw to the first handle.

11. The pair of pliers according to claim 1 including a pin (51) for linking the second handle to the second jaw.

12. The pair of pliers according to claim 1 including a pin (61) for linking the strut to the second handle.

13. The pair of pliers according to claim 1 wherein the strut includes an elbow (63) formed thereon for contact with the lever.

14. The pair of pliers according to claim 1 including a pin (81) for linking the lever to the second handle.

15. The pair of pliers according to claim 14 wherein the pin divides the lever into a first section to be pressed and a second section for contact with the strut.

16. The pair of pliers according to claim 15 wherein the strut includes an elbow (63) formed thereon for contact with the lever.

17. The pair of pliers according to claim 1 wherein the first jaw (30″) includes a series of miniature teeth (34) formed next to the flat edge, wherein the second jaw (40″) includes a series of miniature teeth (44) formed next to the tooth.
